(19) United States
(12) Patent Application Publication
(10) Pub. No.: US 2011/0194279 A1
(43) Pub. Date: Aug. 11, 2011

(54) LED LIGHTING DEVICE WITH LED LAMPS PROTECTED FROM FALLING OFF

(76) Inventor: Hung-Pin Kuo, Taichung City (TW)

(21) Appl. No.: 12/848,687

(22) Filed: Aug. 2, 2010

(30) Foreign Application Priority Data
Feb. 6, 2010 (TW) 099202543

(51) Int. Cl. F21V 1/00; F21V 5/00

(52) U.S. Cl. 362/235; 362/326; 362/311.02

(57) ABSTRACT

A LED lighting device includes a LED module and a diaphanous cover. The LED module includes a circuit board and a plurality of LED lamps. Each of the LED lamps includes a lens unit and a LED package. The lens unit includes a lens body, a frame and at least one pillar. The frame extends from a periphery of the lens body and is mounted on bottom of the circuit board. The pillar extends downward from a bottom surface of the frame. The LED package is mounted in the frame, and has a light emitting surface facing the lens body and a back surface joined to the bottom of the circuit board. The diaphanous cover abuts upward against all distal ends of the pillars of the LED lamps and is secured on the circuit board of the LED module.

### BACKGROUND OF INVENTION

1. Field of Invention

This invention relates to a light emitting diode (herein referred to as LED) lighting device, and more particularly to a LED lighting device which is capable of secure its LED lamps from falling off.

2. Related Prior Art

In general, a conventional LED lighting device, as described in Taiwan Pat. No. M305302, is configured to include a substrate, a number of LED modules mounted on the substrate, a lamp cover upwardly covering all the LED modules, and a plurality of heat sinks for heat dissipation of the LED modules. Each of the LED modules includes a circuit board and a plurality of LED lamps mounted on the circuit board.

Traditionally, to make the LED lighting device, the LED lamps one by one are weld onto the circuit board during the fabrication of the LED modules. The process is relatively heavy and complicated. Moreover, due to possible brittle welds or weak bond, some of the LED lamps may fall off the circuit board and down to the lamp cover after the welding or a short-term use. Thus, the LED lighting device may go from bad to worse and provide uneven or less illumination.

### SUMMARY OF INVENTION

It is an object of this invention to provide a LED lighting device which is reasonably easy to assembly.

It is a further object of this invention to provide such a lighting device which includes LED lamps well secured from falling off.

Broadly stated, the present invention is directed to a LED lighting device, comprising a LED module and a diaphanous lamp cover. The LED module includes a circuit board and a plurality of LED lamps mounted on a bottom surface of the circuit board. Each of the LED lamps includes a lens unit and a LED package coupled with the lens unit. The lens unit includes a lens body, a frame and at least one pillar. The frame extends from a periphery of the lens body. The pillar extends downward from a bottom surface of the frame. The LED package is mounted in the frame of the lens unit, and has a light emitting surface facing toward the lens body and a back surface flush with a top surface of the frame. The frame and the LED package together are attached to the bottom surface of the circuit board. The lamp cover abuts upward against all distal ends of the pillars of the LED lamps and is secured on the circuit board to uphold all the LED lamps.

According to the present invention, the pillars are employed to help the lamp cover to support all of the LED lamps. With this simple configuration, all the LED lamps are secured by the lamp cover from falling off the circuit board. The construction of LED lighting device as described above is thus far largely conventional.

Further features and advantages of the present invention will be appreciated by review of the following detailed description of the invention.

### BRIEF DESCRIPTION OF DRAWINGS

The invention is illustrated by the accompanying drawings in which corresponding parts are identified by the same numerals and in which:

FIG. 1 is an explosive perspective view of a LED lighting device in accordance with a first embodiment of this invention;

FIG. 2 is a top side view of a LED lamp of the LED lighting device in FIG. 1;

FIG. 3 is a bottom side view of the LED lamp of FIG. 2;

FIG. 4 is a partial cross-sectional view of the LED lighting device of FIG. 1;

FIG. 5 is a partial cross-sectional view of a LED lighting device in accordance with a second embodiment of this invention;

FIG. 6 is a top side view of a LED lamp of the LED lighting device in FIG. 5;

FIG. 7 is a bottom side view of the LED lamp of FIG. 6;

FIG. 8 is a top view of the LED lamp of FIG. 6;

FIG. 9 is a partial cross-sectional view of a LED lighting device in accordance with a third embodiment of this invention;

FIG. 10 is an explosive perspective view of a LED lighting device in accordance with a fourth embodiment of this invention;

FIG. 11 is a top side view of a lens unit of LED lamp of the LED lighting device in FIG. 10;

FIG. 12 is a bottom side view of the lens unit of FIG. 10;

FIG. 13 illustrates three interlocked lens units in a line according to the fourth embodiment; and

FIG. 14 is a cross-sectional view of the LED lighting device of FIG. 10.

### DETAILED DESCRIPTION OF EMBODIMENTS

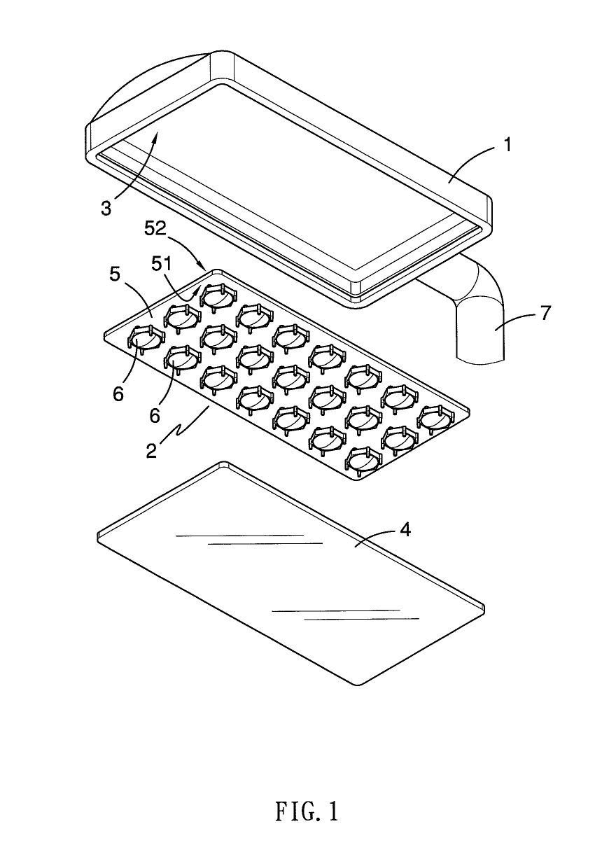

Referring now to FIGS. 1-4 of the drawings, a LED lighting device in accordance with a first embodiment of the invention is a street light and includes a housing 1, a LED module 2, a heat sink 3, a diaphanous lamp cover 4 and a pole 7. The LED module 2 and the heat sink 3 are disposed inside the housing 1. The diaphanous cover 4 is secured on the bottom edges of the housing 1 to cover and protect the LED module 2. The LED module 2 includes a circuit board 5 and a plurality of LED lamps 6 mounted on a bottom surface of the circuit board 5.

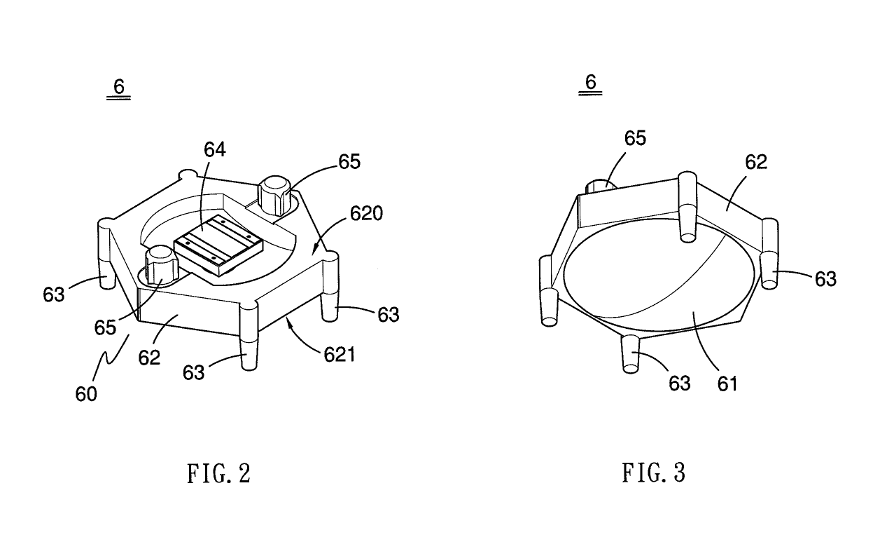

As can be seen in FIGS. 2 and 3, each of the LED lamps 6 includes a lens unit 60 and a LED package 64 mounted in the lens unit 60. The lens unit 60 includes an optical lens body 61, a frame 62 and at least one pillar 63 and at least one positioning post 65. The frame 62 extends from a peripheral of the lens body 61 and has a top surface 620 and a bottom surface 621. In this embodiment, there are four pillars 63 for one lens unit 60. Those pillars 63 equally extend downward from the bottom surface 621 of the frame 62 and share the same height. The LED package 64 is disposed in the frame 62 and has a light emitting surface facing toward the lens body 61 and an opposite back surface being flush with the top surface 620 of the frame 62.

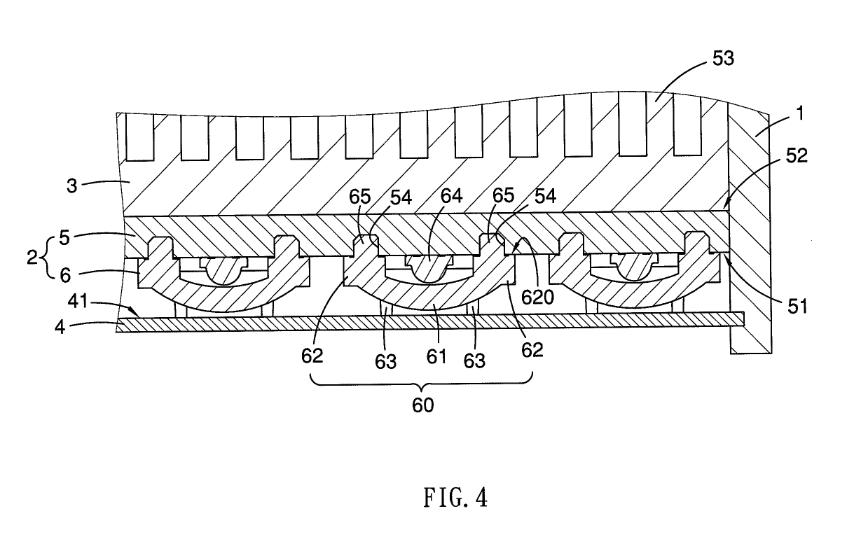

As shown in FIG. 4, the LED lamps 6 are placed in between the heat sink 3 and the diaphanous cover 4. Each of the frames 62 has its top surface 620 attached to the bottom surface 51 of the circuit board 5. The LED package 64 is directly welded on the bottom surface 51 of the circuit board 5. In particular, the pillars 63 of each of the LED lamps 6 has a distal end with a horizontal level lower than or equal to that of the lens body 61. And, the diaphanous cover 4 is joined to the circuit board 5 via the housing 1. That is, the diaphanous cover 4 abuts upward against all the distal ends of the pillars 63 and thereby keeps the LED lamps 6 from falling. Preferably, each of the pillars 63 has its distal end with the horizontal level lower than that of the lens body 61, as shown in FIG. 4, so that a gap can be created between the lens body 61 and the diaphanous cover 4.

On the other hand, each of the posts 65 of the lens units 60 extends upward from the top surface 620 of the frame 62 and be inserted into the corresponding hole 54 of the circuit board 5. In this way, each of the lens units 60 is well positioned and prevented from lateral movement with respect to the LED packages 64. For more reliability, the posts 65 may further be adhered to inner walls of the holes 54 of the circuit board 5 by adhesive. It is noted that the diaphanous cover 4 illustrated in FIG. 4 is indirectly secured onto the circuit board 5 via the bottom edges of the housing 1. However, in other example, the diaphanous cover 4 may be directly screwed onto the circuit board 5.

The heat sink 3 is mounted on the top surface 52 of the circuit board 5 for heat dissipation of the LED module 2. The heat sink 3 includes a number of fins 53 spaced at a distance apart and a heat pipe (not shown) passed through the fins 53 to enhance the dissipation effect.

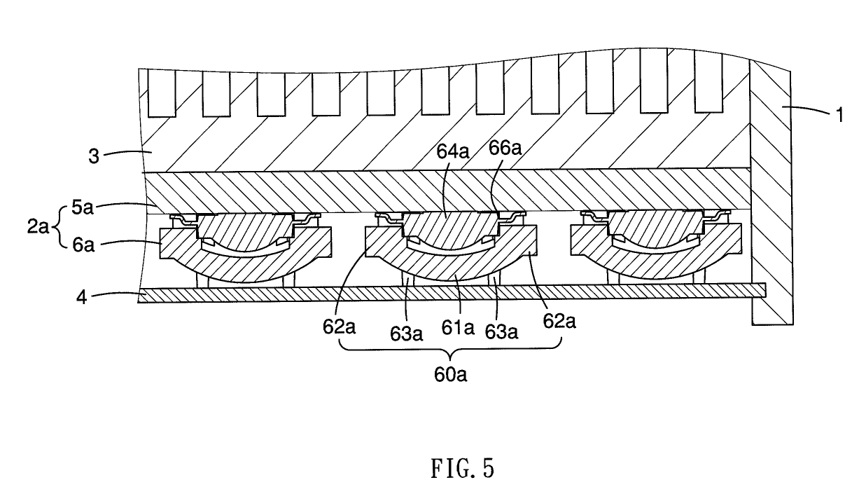

Turing in detail to FIGS. 5-8, a LED lighting device is illustrated in accordance with a second embodiment. As with LED lighting device of FIG. 4, the LED lighting device of the second embodiment includes a housing 1, a LED module 2a, a heat sink 3 and a diaphanous cover 4, except that no posts are formed on top of the LED lamps 6a for positioning. However, in order to make sure that each of the LED packages 64a can always be in alignment with the corresponding lens unit 60a, each of the lens units 60a has a receiving room 66a dimensioned to match the size of the LED package 64a. In such a fashion, the LED package 64a can be kept in the receiving room 66a from horizontal movement so that the LED packages 64a can always be in alignment with the corresponding lens unit 60a.

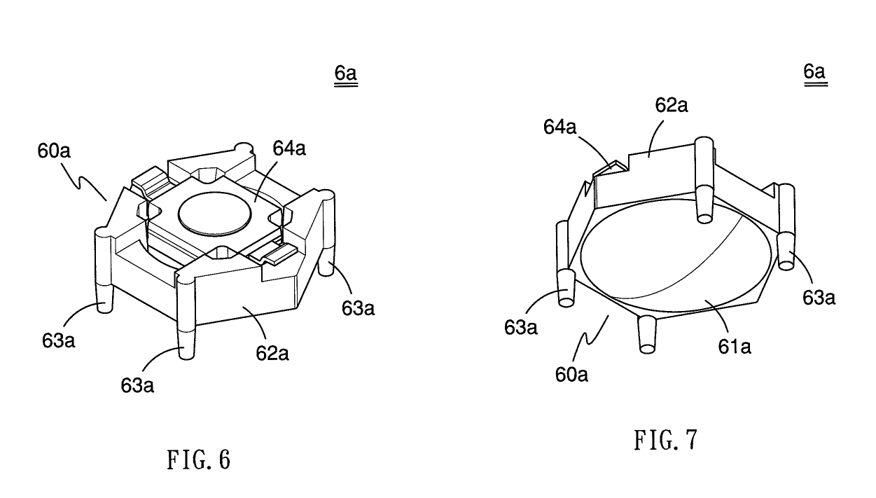

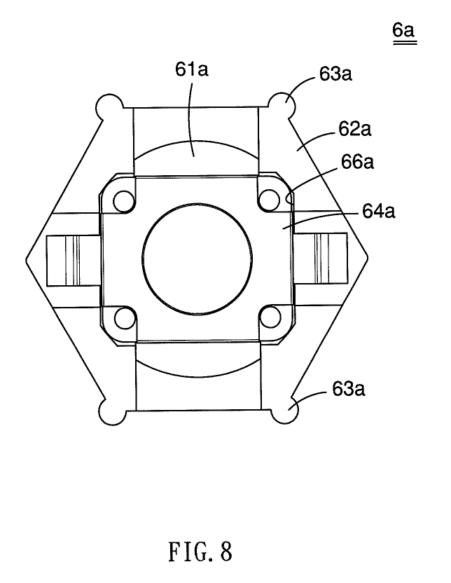

Specifically, as shown in FIGS. 6-7, each of the LED lamps 6a includes the LED package 64a and the lens unit 60a. The lens unit 60a includes a lens body 61a, the frame 62a and at least one pillar 63a, without any posts 65 of FIG. 4. It is apparently that the LED package 64a of FIG. 6 is much bigger than LED package 64 of FIG. 2 in order to fit into the receiving room 66a, as shown in FIGS. 5 and 8. Referring again to FIG. 5, since the LED package 6a is first directly welded on the circuit board 5a and the lens unit 60a is then upwardly engaged with the LED package 6a, the lens units 60a is well positioned without lateral movement.

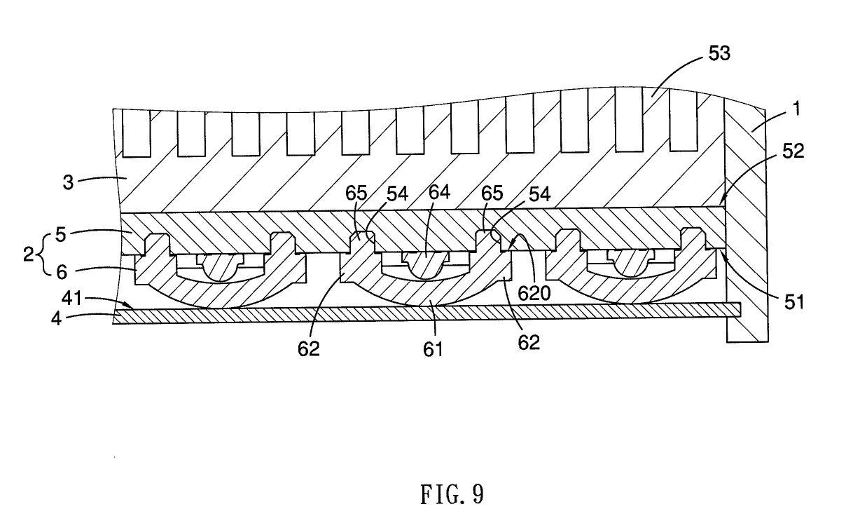

FIG. 9 provides a partial cross-sectional view of a LED lighting device in a third embodiment. The third embodiment is similar to the first embodiment of FIGS. 1-4, except that no pillars are included. However, the diaphanous cover 4 abuts upward against all the lowest portions 61 of the LED lamps 6 to keep the LED lamps 6 from falling off.

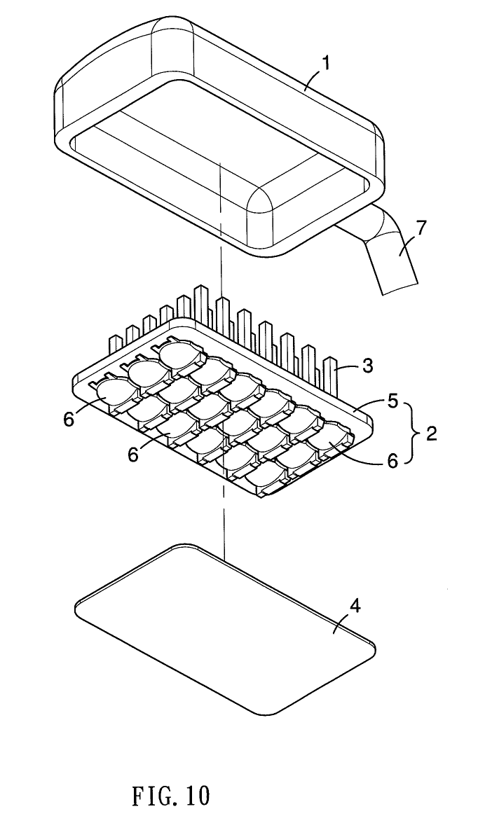

With reference to FIGS. 10-14 of the drawings, a LED lighting device in accordance with a fourth embodiment of the invention is disclosed and includes a housing 1, a LED module 2, a heat sink 3, a diaphanous lamp cover 4 and a pole 7. The LED module 2 and the heat sink 3 are disposed inside the housing 1. The diaphanous cover 4 is secured on the bottom edges of the housing 1 to cover and protect the LED module 2. The LED module 2 includes a circuit board 5 and a plurality of LED lamps 6 mounted on a bottom surface of the circuit board 5.

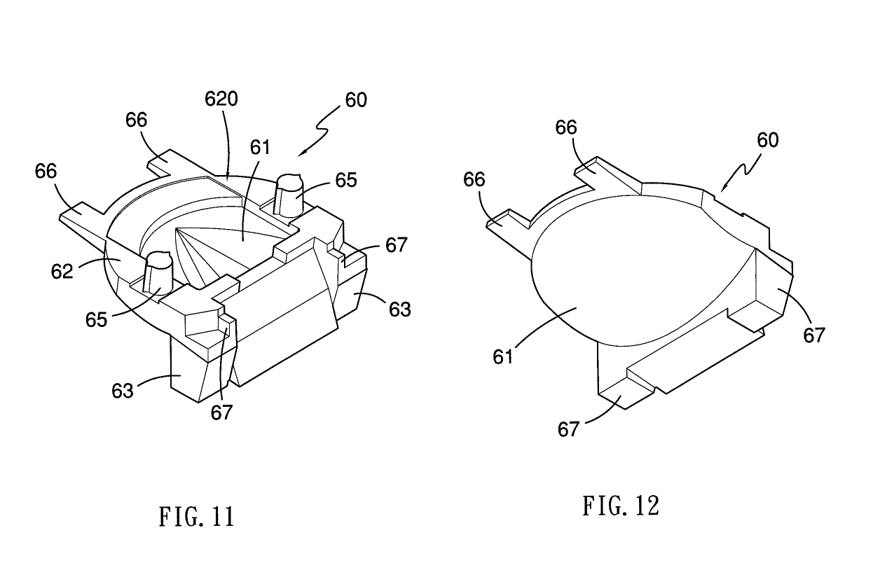

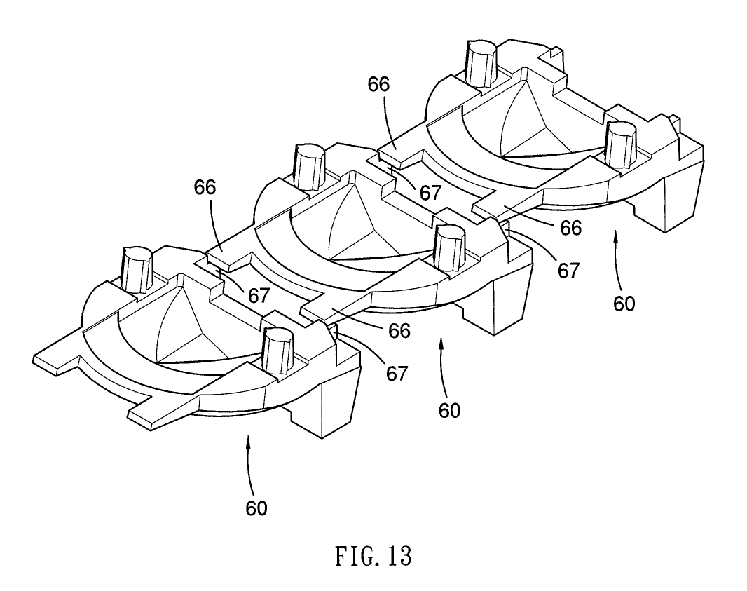

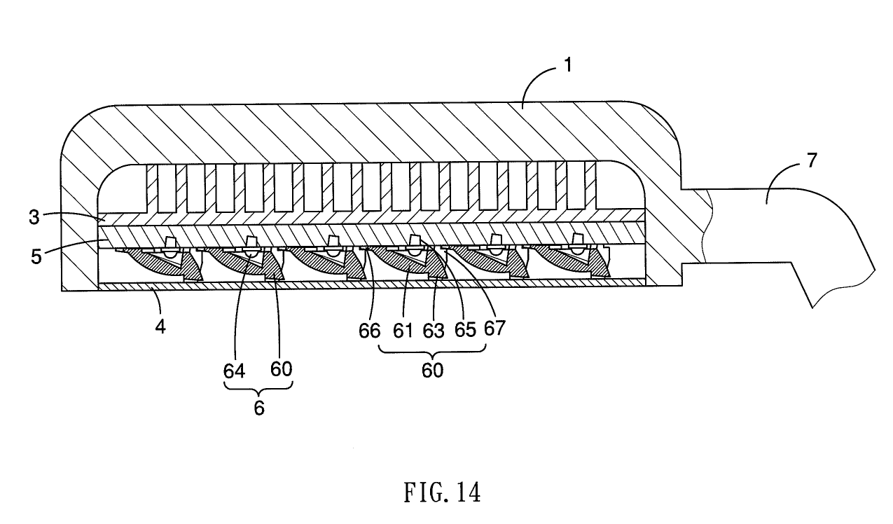

Each of the LED lamps 6 includes a lens unit 60 and a LED package 64 mounted in the lens unit 60, as shown in FIG. 14. As with lens unit of FIGS. 2 and 3, the lens unit 60 of FIGS. 11 and 12 includes an optical lens body 61, a frame 62 and at least one pillar 63 and at least one positioning post 65. The frame 62 extends from a peripheral of the lens body 61 and has a top surface 620 to be joined with a circuit board. In this embodiment, there are only two pillars 63 for one lens unit 60. Those pillars 63 equally extend downward from a bottom surface of the frame 62 and share the same height. The LED package 64 is disposed in the frame 62 and has a light emitting surface facing toward the lens body 61 and an opposite back surface being flush with the top surface 620 of the frame 62. Different from the first embodiment, the lens unit 60 of the fourth embodiment further includes at least one front protrusion 66 and at least one rear supporting portion 67. The front protrusion extends from a front side of the frame 62 while the rear supporting portion is formed on a rear side of the frame 62 where the pillars 63 are located. As best seen in FIG. 13, when three lens units 60 are arranged in a line, the front protrusion 66 of the middle lens unit 60 is upheld by an adjacent rear supporting portion 67 of the front lens unit 60; and the rear supporting portion 67 of the middle lens unit 60 upholds an adjacent front protrusion 66 of the rear lens unit 60. In such a manner, as illustrated in FIG. 14, those lens units 60 can be easily assembled onto the circuit board 5 and therefore interlocked and well-secured between the circuit board 5 and the diaphanous cover 4.

As with the LED lamps 6 of FIG. 4, the LED lamps 6 of FIG. 14 are placed in between the heat sink 3 and the diaphanous cover 4. Each of the frames 62 is mounted on bottom of the circuit board 5. The LED package 64 is directly welded on the bottom surface of the circuit board 5. The pillars 63 of each of the LED lamps 6 has a distal end with a horizontal level lower than or equal to that of the lens body 61. And, the diaphanous cover 4 is joined to the circuit board 5 via the housing 1. That is, the diaphanous cover 4 abuts upward against all the distal ends of the pillars 63 and thereby keeps the LED lamps 6 from falling.

Referring to FIGS. 11 and 14, the posts 65 of the lens units 60 extend upward from the top surface 620 of the frame 62 to be inserted into the corresponding hole 54 of the circuit board 5. In this way, each of the lens units 60 is well positioned and prevented from lateral movement with respect to the LED packages 64. For more reliability, the posts 65 may further be adhered to inner walls of the holes 54 of the circuit board 5 by adhesive. The heat sink 3 is mounted on top of the circuit board 5 for heat dissipation of the LED module 2.

It will be appreciated that although a particular embodiment of the invention has been shown and described, modifications may be made. It is intended in the claims to cover such modifications which come within the spirit and scope of the invention.

The invention claimed is:

1. A lens unit comprising:
an optical lens body;
a frame extending from a periphery of the lens body and having a top surface to be joined with a circuit board; and
at least one pillar extending downward from a bottom surface of the frame and having a horizontal level lower than or equal to that of the lens body.

2. The lens unit of claim 1, further having a receiving room defined by the frame and the lens body for reception of a LED package; and the receiving room is dimensioned to match the size of the LED package such that the lens unit is able to keep the LED package in the receiving room from horizontal movement.

3. The lens unit of claim 1, further comprising at least one front protrusion extending from a front side of the frame and at least one rear supporting portion formed on a rear side of the frame where the pillar is located; wherein when the frame is attached onto the circuit board, the front protrusion of the lens unit is able to be upheld by an adjacent rear supporting portion of another lens unit and the rear supporting portion of the lens unit is able to uphold an adjacent front protrusion of yet another lens unit.

4. The lens unit of claim 3, further comprising at least positioning post extending upward from the top surface of the frame to be inserted into a corresponding hole of the circuit board.

5. A LED lamp for being mounted on a circuit board, comprising:
a lens unit including a lens body, a frame and at least one pillar; the frame extending from a periphery of the lens body and having a top surface to be joined with the circuit board; the pillar extending downward from a bottom surface of the frame and having a horizontal level lower than or equal to that of the lens body; and
a LED package mounted in the frame, and having a light emitting surface facing toward the lens body and a back surface being flush with the top surface of the frame to be joined to the circuit board.

6. The LED lamp of claim 5, wherein the lens unit further comprises at least one front protrusion extending from a front side of the frame and at least one rear supporting portion formed on a rear side of the frame where the pillar is located; and when the frame is attached onto the circuit board, the front protrusion of the lens unit is able to be upheld by an adjacent rear supporting portion of another lens unit and the rear supporting portion of the lens unit is able to uphold an adjacent front protrusion of yet another lens unit.

7. The LED lamp of claim 5, further comprising at least one post extending upward from the top surface of the frame to be inserted into a corresponding hole of the circuit board.

8. The LED lamp of claim 5, wherein the lens unit has a receiving room defined by the frame and the lens body to receive the LED package; the receiving room is dimensioned to match the size of the LED package such that the LED package can be kept in the receiving room from horizontal movement.

9. A LED lighting device, comprising:
a LED module including a circuit board and a plurality of LED lamps mounted on a bottom surface of the circuit board; each LED lamp including a lens unit and a LED package; the lens unit including a lens body and a frame;
the frame extending from a periphery of the lens body and having a top surface joined with the bottom surface of the circuit board; the LED package mounted in the frame of the lens unit and having a light emitting surface facing toward the lens body and a back surface which is flush with the top surface of the frame and joined to the bottom surface of the circuit board; and
a diaphanous cover abutting upward against all distal bottom ends of the LED lamps and secured onto the circuit board of the LED module so as to uphold all the LED lamps.

10. The LED lighting device of claim 9, wherein the lens unit further includes at least one pillar extending downward from a bottom surface of the frame; and the diaphanous cover abuts against all distal bottom ends of the pillars of the LED lamps to uphold all the LED lamps.

11. The LED lighting device of claim 10, wherein the lens unit further comprises at least one front protrusion extending from a front side of the frame and at least one rear supporting portion formed on a rear side of the frame where the pillar is located; and when the frame is attached onto the circuit board, the front protrusion of the lens unit is able to be upheld by an adjacent rear supporting portion of another lens unit and the rear supporting portion of the lens unit is able to uphold an adjacent front protrusion of yet another lens unit.

12. The LED lighting device of claim 10, wherein each of the LED lamps further comprising at least one post extending upward from the top surface of the frame and being received in a corresponding hole of the circuit board.

13. The LED lighting device of claim 10, wherein the lens unit has a receiving room defined by the frame and the lens body to receive the LED package; the receiving room is dimensioned to match the size of the LED package such that the LED package can be kept in the receiving room from horizontal movement.

14. The LED lighting device of claim 10, further comprising a heat sink mounted on top of the circuit board.
